(19) United States
(12) Patent Application Publication
(10) Pub. No.: US 2004/0103214 A1
(43) Pub. Date: May 27, 2004

(54) Method, apparatus, and system for enterprise management of mobile and non-mobile terminals

(76) Inventors: Sandeep Adwankar, Schaumburg, IL (US); Nitya Narasimhan, Schaumburg, IL (US); Venugopal Vasudevan, Palatine, IL (US)

Correspondence Address: MOTOROLA, INC., 1303 EAST ALGONQUIN ROAD, IL01/3RD, SCHAUMBURG, IL, 60196

(21) Appl. No.: 10/302,120

(22) Filed: Nov. 22, 2002

(51) Int. Cl. G06F 15/16; G06F 15/173

(52) U.S. Cl. 709/246; 709/230; 709/229

(57) ABSTRACT

To address the need for managing both mobile (109-111) and non-mobile (112-113) terminals without the need for terminals to support multiple system managing protocols, a method, apparatus, and system for enterprise management is described herein. A gateway (102) is provided that translates and schedules commands for the non-mobile network into commands for the mobile network. Such a gateway (102) allows for the system manager to utilize a single network management protocol to access both the mobile and non-mobile networks.

### FIELD OF THE INVENTION

The present invention relates generally to enterprise management and in particular, to a method, apparatus, and system for enterprise management of mobile and non-mobile terminals.

### BACKGROUND OF THE INVENTION

Enterprise management systems are well known in the art. Such management systems manage devices, applications, and software for terminals that are part of an enterprise network. Non-mobile networks, where terminals are stationary, typically employ adopted industry standard protocols, such as the Simple Network Management Protocol (SNMP), for managing terminals. Because mobile terminals do not typically have enough device and/or network resources to house an SNMP agent, enterprise management for these devices typically takes place utilizing lower-bandwidth, lower-overhead protocols such as the SyncML management protocol. As with the SNMP management protocol, the SyncML is an open industry protocol designed to facilitate management of different devices connected to the network.

Because mobile devices (e.g., cellular telephones) are providing more functionality than those available in the past, mobile devices are becoming an increasingly integral part of any enterprise computing environment. For example, the availability of new technologies such as Java 2 Micro Edition (J2ME), the General Packet Radio Service (GPRS), and the ability to access enterprise information using applications such as email, make mobile terminals an integral part of an enterprise computing environment. Because of this, the enterprise environment now consists of both SNMP-based terminals and resource-constrained terminals. Thus, today's enterprise manager faces the problem of having two entirely separate management systems to managing both mobile and non-mobile devices. Furthermore, many enterprise users are likely to own both mobile and non-mobile devices that must collaborate to execute applications. In such cases, debugging a problem that potentially spans both domains is difficult given that each device is managed by a different system. Therefore a need exists for a method and apparatus for managing both mobile and non-mobile terminals without the need for terminals to support multiple system managing protocols.

### BRIEF DESCRIPTION OF THE DRAWINGS

FIG. 1 is a block diagram of a enterprise management system in accordance with the preferred embodiment of the present invention.

FIG. 2 is a block diagram of the terminal management gateway of FIG. 1 in accordance with the preferred embodiment of the present invention.

FIG. 3 is a call-flow diagram showing operation of the enterprise management system of FIG. 1 in accordance with the preferred embodiment of the present invention.

FIG. 4 is a flow chart showing operation of the enterprise management system of FIG. 1 in accordance with the preferred embodiment of the present invention.

FIG. 5 is a flow chart showing operation of the gateway of FIG. 2 in accordance with the preferred embodiment of the present invention.

### DETAILED DESCRIPTION OF THE DRAWINGS

To address the need for managing both mobile and non-mobile terminals without the need for terminals to support multiple system managing protocols, a method, apparatus, and system for enterprise management is described herein. In accordance with the preferred embodiment of the present invention a gateway is provided that translates and schedules commands for the non-mobile network into commands for the mobile network. Such a gateway allows for the system manager to utilize a single network management protocol to access both the mobile and non-mobile networks.

The present invention encompasses a method for enterprise management. The method comprises the steps of receiving a first enterprise management command belonging to a first enterprise management protocol, translating the first enterprise management command to a second enterprise management command belonging to a second enterprise management protocol, and transmitting the second enterprise management command to a mobile-terminal management system that utilizes the second enterprise management command protocol to manage mobile terminals.

The present invention additionally encompasses a system for enterprise management. The system comprises the steps of issuing a first enterprise management command belonging to a first enterprise management protocol, translating, by a gateway, the first enterprise management command belonging to the first enterprise management protocol to a second enterprise management command belonging to s second enterprise management protocol, and sending from the gateway, the second enterprise management command to a mobile terminal management system. The second enterprise management command is then sent from the mobile terminal management system through a radio-access network to a mobile terminal and a response from a mobile terminal management system is received. Finally, the response is transmitted from the mobile terminal to the gateway.

The present invention additionally encompasses a method comprising the steps of receiving a simple network management protocol (SNMP) command, translating an address associated with the command to a mobile address, translating the SNMP command to a SyncML command, scheduling the SyncML command, and transmitting the SyncML command to a mobile terminal management system.

The present invention additionally encompasses an apparatus comprising logic circuitry receiving a first enterprise management command belonging to a first enterprise management protocol, a protocol converter for translating the first enterprise management command to a second enterprise management command belonging to a second enterprise management protocol, and a scheduler for transmitting the second enterprise management command to a mobile-terminal management system that utilizes the second enterprise management command protocol to manage mobile terminals.

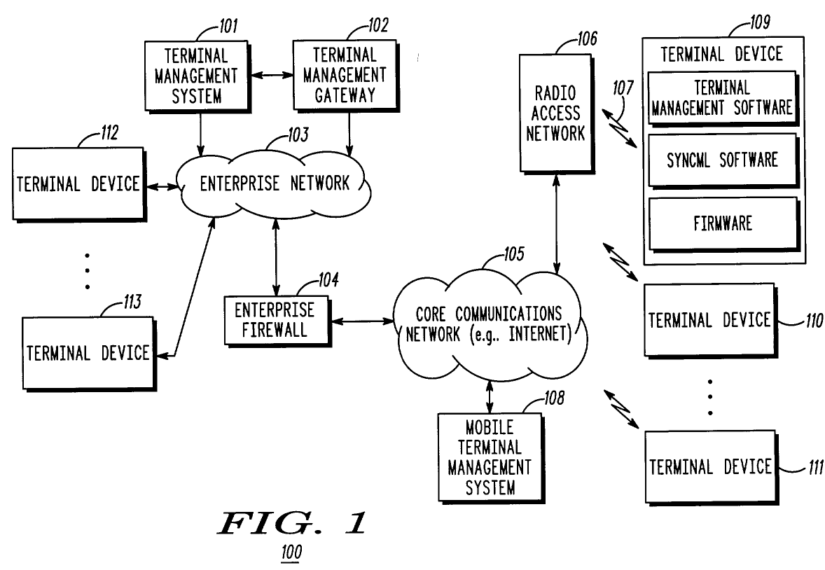

Turning now to the drawings, wherein like numerals designate like components, FIG. 1 is a block diagram of enterprise management system 100 in accordance with the preferred embodiment of the present invention. As shown, there exists enterprise network 103 and radio access network 106 connected via a core communications network, such as Internet 105. Enterprise management system 100 comprises terminal management system 101, enterprise network 103, and terminal devices 112-113. In the preferred embodiment of the present invention network 103 is a local-area network (LAN), however, one of ordinary skill in the art will recognize that network 103 may take various forms, such as, but not limited to enterprise extranets that consist of multiple linked LANs, cellular operator infrastructures that may be hosted over a wide-area network (WAN) or a metropolitan area network (MAN).

Devices 112-113 are preferably personal computers, however devices 112-113 may comprise any device connected to network 103 that is capable of being controlled by the system protocol utilized by terminal management system 101. In the preferred embodiment of the present invention terminal management system 101 utilizes an SNMP management protocol to control devices 112-113, however one of ordinary skill in the art will recognize that other protocols (e.g., CMIP, CORBAIIOP, RMI), . . . , etc.) may be utilized as well.

As is known in the art, the SNMP management protocol comprises Management Information Bases (MIBs) that define collections of properties of managed object within the managed terminal, Object identifiers for universal unambiguous identification of managed objects, a set of management commands, and responses that are transmitted over a connectionless communication network. The SNMP protocol defines the commands that an SNMP manager can send to network elements that are managed using SNMP. Protocol commands include Get and Set, The management system issues SNMP commands (which are part of the SNMP protocol) to an agent to retrieve single or multiple object variables or to establish the value. The managed agent sends a Response message to these commands. Managed agent can send event notification to management system to identify occurrence of certain condition.

As is evident, system 100 also comprises radio-access network (RAN) 106 that is utilized to control terminal devices (SyncML management objects) 109-111. Terminal devices 109-111 are preferably cellular telephones, however terminal devices 109-111 may comprise other devices such as, but not limited to handhelds such as PDA's, PocketPCs, and wireless e-mail devices.

Over-the-air communications 107 facilitate communication between terminal devices 109-111 and RAN 106. As one of ordinary skill in the art will recognize, over-the-air communication 107 may comprise any number of over-the-air protocols such as, but not limited to a Code Division Multiple Access (CDMA) system protocol, a Global System for Mobile Communications (GSM) protocol, a Wideband CDMA system protocol, . . . , etc.

Management of terminal devices 109-111 take place via mobile terminal management system 108. In the preferred embodiment of the present invention management system 108 utilizes a SyncML system protocol, however one of ordinary skill in the art will recognize that other low-overhead protocols (e.g., WAP Provisioning, 3GPP User Equipment Management) may be utilized as well.

The SyncML management protocol accesses and controls management objects such as devices 109-111. Management objects can be manipulated by management actions, carried over the SyncML protocol. Each management object is a specific type of object that determines what kind of management content can be set/read on that object. A management object might reflect a set of configuration parameters for a device. Actions that might be taken against this object might include reading and setting parameter keys and values. A different management object might be the runtime environment for software applications on the device. Actions that can be taken against this type of object might include installing, upgrading, uninstalling software elements.

As described above, because the enterprise environment of enterprise management system 100 consists of both SNMP-based terminals and SyncML-based terminals, an enterprise manager faces the problem of having two entirely separate management protocols to managing both mobile and non-mobile devices. In order avoid the fragmentation of terminal management system 101 and mobile terminal management system 108, and to provide a uniform management system for all enterprise computing needs, terminal management gateway 102 is introduced.

Terminal management gateway 102 is a software entity that continuously advertises the presence of terminal devices 109-111 and translates any SNMP command to a corresponding SyncML command. More generally, gateway 102 receives a management command utilizing a first protocol for a higher-bandwidth, higher-overhead protocol, and translates/schedules the command to the lower-bandwidth, lower-overhead protocol. This is accomplished by using a common administrative interface that transparently maps management commands onto management protocols appropriate for the managed devices when necessary.

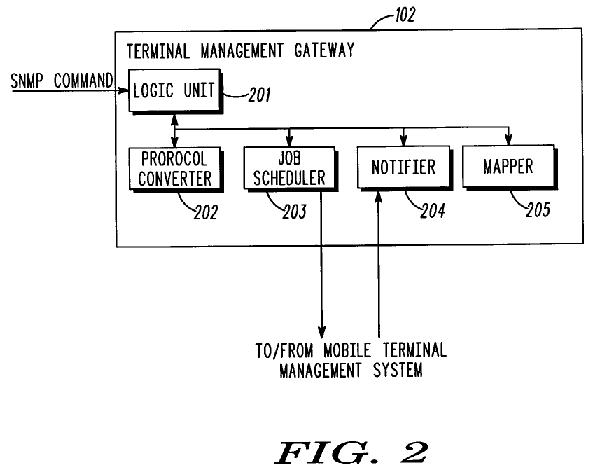

FIG. 2 is a block diagram of terminal management gateway 102 in accordance with the preferred embodiment of the present invention. As shown, gateway 102 comprises logic circuitry 201, protocol converter 202, scheduler 203, notifier 204, and mapper 205. Protocol converter 202 is responsible for conversion of enterprise protocol to terminal management protocol, in this case SNMP to SyncML. Thus, protocol converter 202 transforms SNMP PDU's to SyncML packages. In this transformation process, SNMP security credentials are converted to SyncML based security credentials required by mobile terminal management system 108.

Mapper 205 maps address of terminals 109-111 to an enterprise address space. Thus, mapper 205 allows mapping of terminal's unique identification code (e.g. International Mobile Equipment Identity (IMEI)) to enterprise local private IP address space. As discussed above, gateway 102 constantly advertises reachability to this local private IP address space from enterprise address space. It then provides translation from the local private IP address space to the terminal IMEI.

Job Scheduler 203 balances terminal management activities. In particular, scheduler 203 schedules terminal management operations depending on the terminal management server availability and availability of scarce wireless resources. For example, the management operation of a software upgrade to large number of terminals may be scheduled at 2.00 AM, when wireless resources are cheap and plentiful.

Finally, notifier 204 allows the notification of terminal management system 101 after a terminal management task is complete. In particular, since the time taken for mobile terminal management is more than that expected in enterprise management, notifier 204 sends a response code for “Management Action in progress” and notifies with the result and status when management action is complete. The notifier mechanism avoids the need for an enterprise management system to actively and repeatedly poll a large number of mobile devices. Also because mobile devices suffer more frequent disconnections from the network than standard enterprise devices, notifier 204 hides such behavior from the enterprise management system by allowing these devices to report their status/results asynchronously upon their subsequent reconnection.

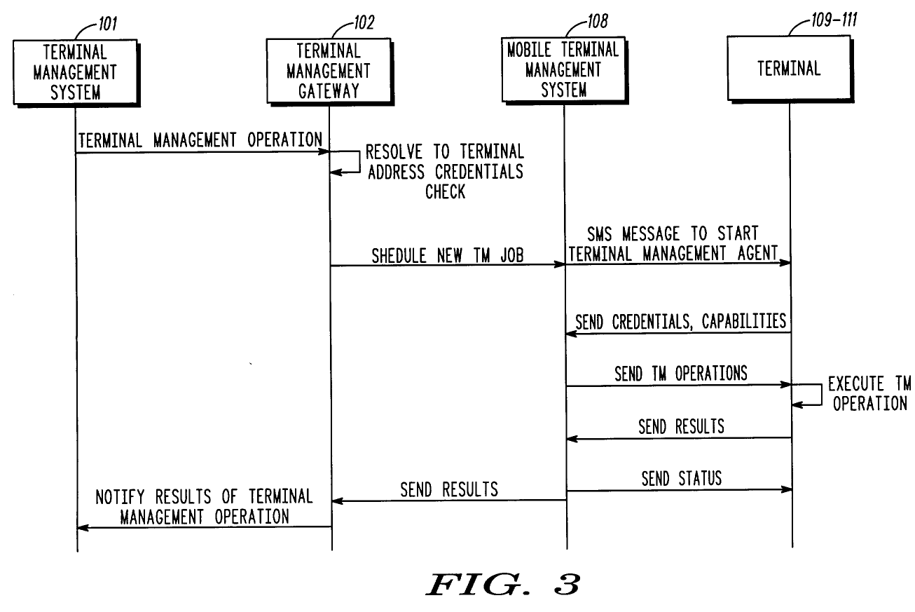

FIG. 3 is a call-flow diagram showing operation of the enterprise management system of FIG. 1 in accordance with the preferred embodiment of the present invention. During the call flow, terminal management system 101 sends a terminal management operation to gateway 102. Terminal management operation may comprise any number of operations such as, but not limited to tracking, configuration, fault diagnosis and repair, software upgrade, asset management, performance monitoring. Gateway 102 resolves the terminal address to a mobile address and schedules the operation with mobile terminal management system 108. Mobile terminal management system 108 performs normal terminal management utilizing a low-overhead system protocol (e.g., SyncML). As part of the SyncML protocol, an short message service (SMS) is utilized to send an SMS message to the particular terminal (e.g., terminal 109) requesting access to terminal 109. Credentials are exchanged and the command is sent, and executed by terminal 109. Terminal 109 sends the results of the execution which are relayed back to terminal management system 101 via gateway 102.

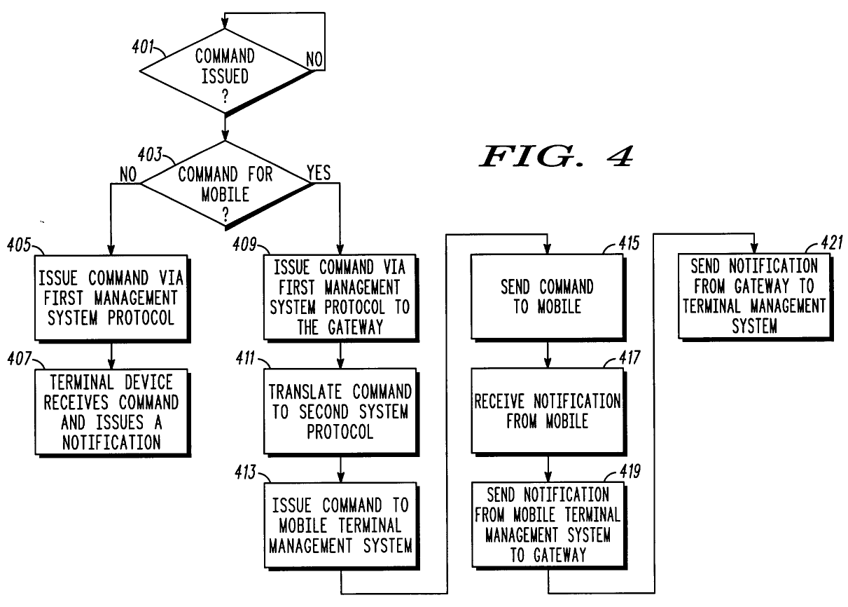

FIG. 4 is a flow chart showing operation of the enterprise management system of FIG. 1 in accordance with the preferred embodiment of the present invention. The following description will be given with regard to terminal management system 101 utilizing an SNMP protocol and mobile terminal management system 108 utilizing a SyncML system protocol, however one of ordinary skill in the art will recognize that either system may employ a number of varying protocols for enterprise management. Additionally, the following description gives a scenario where a single command is issued to a single device, however one of ordinary skill in the art will recognize that a single command can be simultaneously issued to multiple devices existing within multiple networks.

The logic flow begins at step 401 where a command is issued by terminal management system 101. In the preferred embodiment of the present invention the command comprises a simple SNMP command that may instruct a terminal device to get (ask a device-resident agent to send the value of an SNMP measurand to the manager), set (ask the device-resident agent to modify the value of an SNMP measurand). At step 403 terminal management system 101 determines if the command is to be issued to a mobile device, and if not, the logic flow continues to step 405 where the command is issued utilizing a first management system protocol (SNMP). At step 407 a terminal device within the enterprise network receives the command and issues a notification to terminal management system 101.

Returning to step 403, if the command is determined to be for a mobile device then the command is issued via the SNMP system protocol to gateway 102 (step 409). Gateway 102 translates the command to a second system protocol (SyncML) (step 411) and issues the command to mobile terminal management system 108 (step 413). The command is sent from mobile terminal management system 108 to the mobile via radio access network 106 (step 415). Mobile terminal management system 108 eventually receives a notification from the mobile (step 419) and sends the notification to gateway 102 (step 419) where it is eventually sent to terminal management system 101 (step 421).

As is evident, gateway 102 allows terminal management system 101 to communicate with both non-resource-constrained terminals and resource-constrained terminals with a single management system protocol. Therefore, the prior-art problem of having two entirely separate management systems to managing both mobile and non-mobile devices has been eliminated.

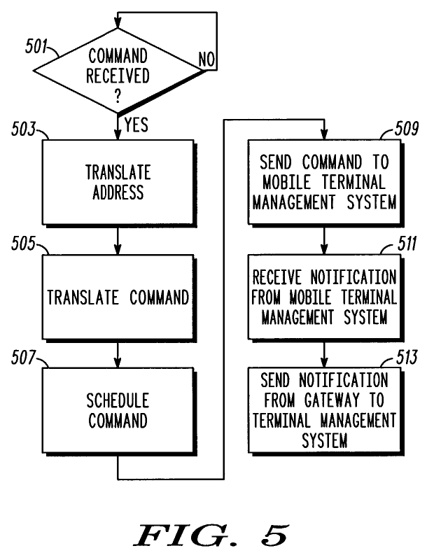

FIG. 5 is a flow chart showing operation of gateway 102 of FIG. 2 in accordance with the preferred embodiment of the present invention. The logic flow begins at step 501 where logic circuitry 201 receives the SNMP command and accesses mapper 205. At step 503 mapper 205 translates the current address to a mobile address and at step 505 protocol converter 202 is accessed to translate the SNMP command to a SyncML command. Logic circuitry 201 then schedules the command with scheduler 203 (step 507). As discussed above, the scheduler optimizes the scalable dissemination of management commands to large numbers of devices. For instance, the scheduler could bundle a collection of commands destined to a single terminal, or a single command destined to a collection of terminals within a single cell.

Continuing, once an appropriate time is reached, scheduler 203 transmits the SyncML command to mobile terminal management system 108 (step 509). At step 511, notifier 204 receives notification from mobile terminal management system 108 and this notification is sent passed to logic circuitry 201 and eventually to management system 101 (step 513).

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for enterprise management, the method comprising the steps of:
receiving a first enterprise management command belonging to a first enterprise management protocol;
translating the first enterprise management command to a second enterprise management command belonging to a second enterprise management protocol; and
transmitting the second enterprise management command to a mobile-terminal management system that utilizes the second enterprise management command protocol to manage mobile terminals.

2. The method of claim 1 wherein the step of receiving the first enterprise management command comprises the step of receiving a Simple Network Management Protocol (SNMP) command.

3. The method of claim 2 wherein the step of translating the first enterprise management command comprises the step of translating the first enterprise management command from the SNMP to a SyncML protocol.

4. The method of claim 1 wherein the step of translating the first enterprise management command comprises the step of translating the first enterprise management command to a second enterprise management command belonging to a SyncML protocol.

5. The method of claim 4 wherein the step of transmitting the second enterprise management command to the mobile-terminal management system comprises the step of transmitting the second enterprise management command to a SyncML terminal management system.

6. The method of claim 1 further comprising the step of:
scheduling the second enterprise management command.

7. A system for enterprise management, the system comprising the steps of:
issuing a first enterprise management command belonging to a first enterprise management protocol;
translating, by a gateway, the first enterprise management command belonging to the first enterprise management protocol to a second enterprise management command belonging to s second enterprise management protocol;
sending from the gateway, the second enterprise management command to a mobile terminal management system;
sending the second enterprise management command from the mobile terminal management system through a radio-access network to a mobile terminal;
receiving, by the mobile terminal management system, a response from the mobile terminal; and
transmitting the response from the mobile terminal to the gateway.

8. The method of claim 7 wherein the step of issuing a first enterprise management command comprises the step of issuing a Simple Network Management Protocol (SNMP) command.

9. The method of claim 8 wherein the step of translating the first enterprise management command comprises the step of translating the first enterprise management command from the SNMP to a second enterprise management command belonging to a SyncML management protocol.

10. The method of claim 7 wherein the step of translating the first enterprise management command comprises the step of translating the first enterprise management command to a second enterprise management command belonging to a SyncML protocol.

11. The method of claim 10 wherein the step of transmitting the second enterprise management command to the mobile-terminal management system comprises the step of transmitting the second enterprise management command to a SyncML terminal management system.

12. A method comprising the steps of:
receiving a simple network management protocol (SNMP) command;
translating an address associated with the command to a mobile address;
translating the SNMP command to a SyncML command;
scheduling the SyncML command; and
transmitting the SyncML command to a mobile terminal management system.

13. An apparatus comprising:
logic circuitry receiving a first enterprise management command belonging to a first enterprise management protocol;
a protocol converter for translating the first enterprise management command to a second enterprise management command belonging to a second enterprise management protocol; and
a scheduler for transmitting the second enterprise management command to a mobile-terminal management system that utilizes the second enterprise management command protocol to manage mobile terminals.

14. The apparatus of claim 13 wherein the first enterprise management protocol is a simple network management protocol.

15. The apparatus of claim 13 wherein the second enterprise management protocol is a SyncML management protocol.

16. The apparatus of claim 13 wherein the first enterprise management protocol is a simple network management protocol and the second enterprise management protocol is a SyncML management protocol.
